(19) United States
(12) Patent Application Publication
(10) Pub. No.: US 2007/0297027 A1
(43) Pub. Date: Dec. 27, 2007

(54) Modular spring system

(75) Inventor: Tapio Karkkola, Turku (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/453,754

(22) Filed: Jun. 14, 2006

(51) Int. Cl. H04N 1/04

(52) U.S. Cl. 358/498

(57) ABSTRACT

A modular spring system has a module body to accommodate a cam shaft holder on one end and a blocking surface on the other end. The cam shaft holder has a well to accommodate a cam shaft, allowing the cam shaft to rotate therein. The well has an open section and the cam shaft has a cam tip located near the open section. A slider with a protruding portion is used to press against the cam tip through the open section of the well to provide a nose-to-nose interface. A spring is inserted between the blocking surface and the slider to provide stability of a nose-to-nose interface position. Depending on the shape of the protruding portion of the slider and the shape of the cam tip, the modular spring system can have one, two or more stable nose-to-nose interface positions.

### FIELD OF THE INVENTION

The present invention relates generally to a modular spring system and, more particularly, to a nose-to-nose modular spring system.

### BACKGROUND OF THE INVENTION

A small portable device, such as a mobile phone, a communicator device and a personal digital assistant, requires a mechanical linkage between two device parts, such as a cover and a device body, so that one device part can be moved to different positions relative to the other device part. It is desirable that the mechanical linkage is small but reliable. Furthermore, when one device part is moved between positions relative to the other device part, the mechanical linkage is stable at least at one of the positions. Furthermore, the required distance between the relative positions is quite large. In a slide mechanism for use in a small device, the required torsion response (negative or position moment) is often relatively high.

It is thus desirable and advantageous to provide a mechanical device that meets the above-mentioned requirements.

### SUMMARY OF THE INVENTION

A modular spring system has a module body to accommodate a cam shaft holder on one end and a blocking surface on the other end, along a body axis. The cam shaft holder has a well to accommodate a cam shaft, allowing the cam shaft to rotate therein about a rotational axis. The rotational axis is substantially perpendicular the body axis of the module body. The well has an open section and the cam shaft has a cam tip located near the open section. A slider with a protruding portion is used to press against the cam tip through the open section of the well to provide a nose-to-nose interface. A spring is inserted between the blocking surface and the slider to provide stability of a nose-to-nose interface position. Depending on the shape of the protruding portion of the slider and the shape of the cam tip, the modular spring system can have one, two or more stable nose-to-nose interface positions. When the cam shaft is rotated so as to move the cam tip from one stable position to another stable position, the slider is caused to temporarily move backward. The cam shaft also has a locking member inserted into a recess or an opening on the cam shaft holder. The locking member prevents the cam shaft from moving out of the well along the rotational axis while allowing the cam shaft to rotate between nose-to-nose interface positions.

The modular spring system can be used on a device having two device parts to allow the device to have stable open and closed positions.

The present invention will become apparent upon reading the description taken in conjunction with FIGS. 1 to 11.

### BRIEF DESCRIPTION OF THE DRAWINGS

FIG. 1 is an isometric view of the modular spring system, according to one embodiment of the present invention, wherein the spring is shown separately from the module body.

FIG. 2 is an isometric view of the module body, according to one embodiment the present invention.

FIG. 3 is an isometric view of the cam shaft, according to one embodiment of the present invention.

FIG. 4 is an isometric view of the slider, according to one embodiment of the present invention.

FIG. 5 is a top view showing different nose interfaces of the module.

FIG. 6 is a top view of a shaft and a slider showing the bi-stable nature of the modular spring system, according to one embodiment of the present invention.

FIG. 7 is a top view of a shaft and a slider showing a mono-stable modular spring system, according to a different embodiment of the present invention.

FIG. 8 is a top view of a shaft and a slider showing a tri-stable module spring system, according to yet another embodiment of the present invention.

FIG. 9 is an exemplary application where the modular spring system is used as a sliding hinge to allow a first part of a device to slide against a second part of the device.

FIG. 10 is another exemplary application where the modular spring system is used in a clamp-shell device.

FIG. 11 is a flowchart illustrating a method of producing the modular spring system, according to an embodiment of the present invention.

### DETAILED DESCRIPTION OF THE INVENTION

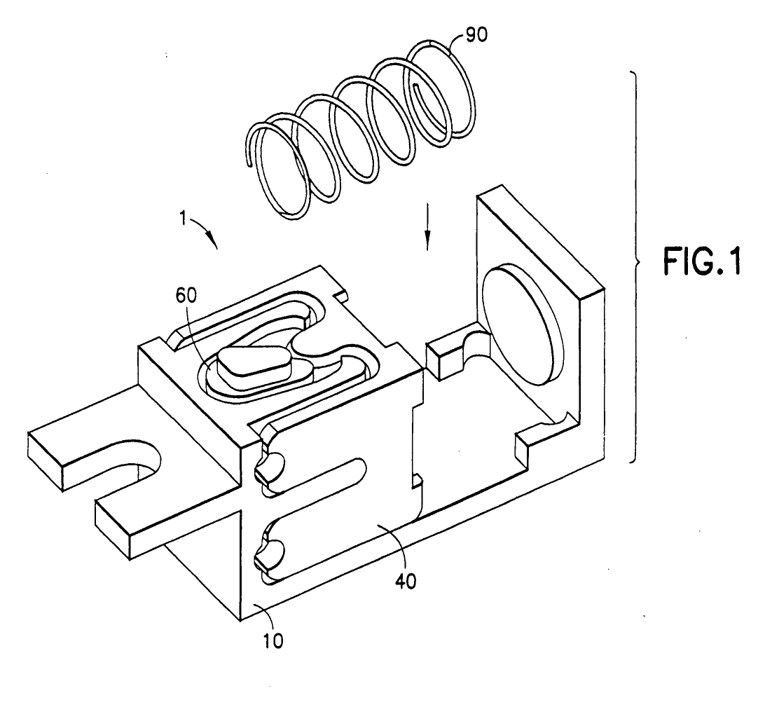

The modular spring system 1, according to the present invention, has a module body 10 to hold a cam shaft 60 and a slider 40 to provide nose interfaces between the slider and the cam shaft. A stiff spring 90 is used to urge the slider to press against the cam shaft, as shown in FIG. 1.

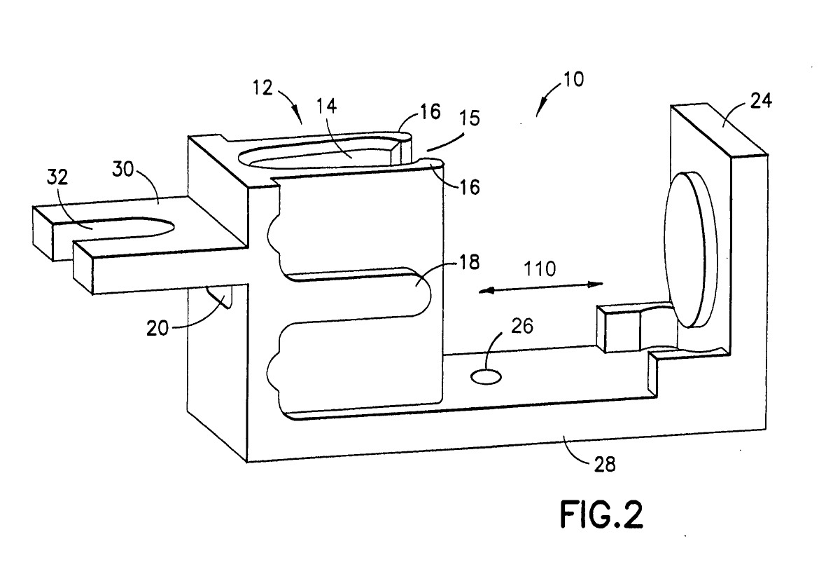

As shown in FIG. 2, the module body 10 has a base 28, a cam shaft holder 12 located on one end and an end wall 24 on the other end. The cam shaft holder 12 has two arms 16 to define a shaft well 14. Each of the arms 16 has an alignment guide 18 to guide the slider 40 into position in the assembling process. The base 28 has a mounting hole 26. The cam shaft holder has a retaining aperture 20 to prevent the cam shaft 60 from sliding out of the shaft well 14 after all the components are assembled. The module body 10 also has a mounting bracket 30 with a mounting slot 32. The mounting slot 32 and the mounting hole 26 can be used for mounting the modular spring module 1 to be mounted on a device or structure.

FIG. 3 is an isometric view of the cam shaft 60. As shown, the cam shaft 60 has a shaft 68 rotatable about a rotation axis 160. The shaft 68 has a locking member 64 protruding from the shaft surface. The locking member 64 is dimensioned to be moved into the retaining aperture 20 of the cam shaft holder. The retaining aperture 20 is wider than the locking member 64 so as to allow the shaft to rotate about the rotation axis within a predetermined angular range. The shaft 68 has a cam tip 70 which is used to provide a nose interface with the slider 40. A joint 62, located on top of the shaft 68, is used to provide a mechanical linkage to an external part.

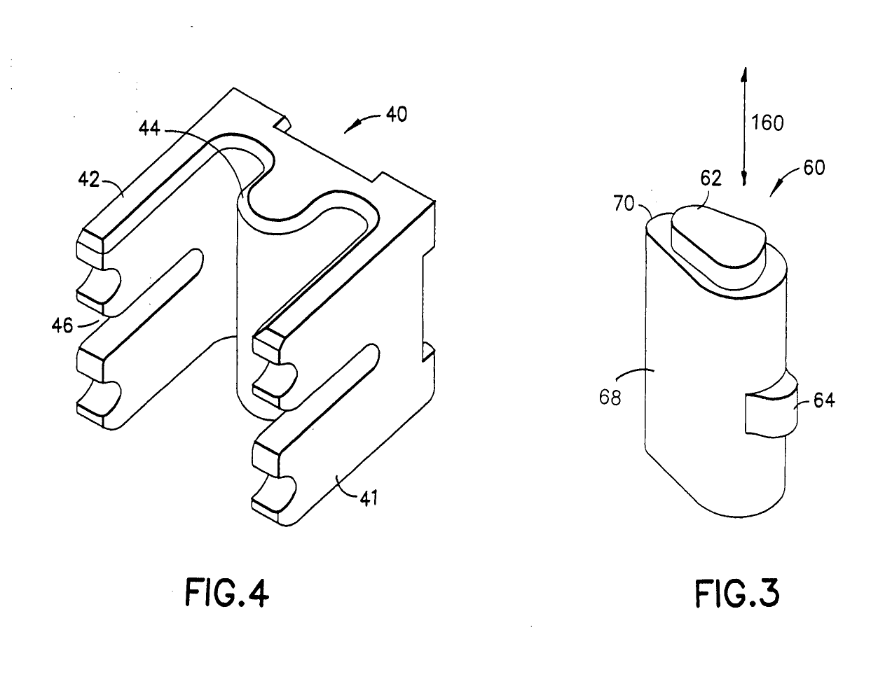

FIG. 4 shows an isometric view of the slider 40. As shown, the slider 40 has a first side wall 41, a second side wall 42 and a protruding member 44 located between the two side walls 41, 42. Each of the side walls has a guiding slot 46 to be slid into the alignment guides 18 for assembling after the cam shaft 60 is placed into the shaft well 14 with the locking member 64 of the cam shaft 60 being inserted into the retaining aperture 20. After the cam shaft 60, the slider 40 and the module body 10 are properly assembled, a spring 90 is inserted in the space between the end wall 24 and the slider 40. The spring 90 provides a force to urge the protruding member 44 to press against the cam tip 70 of the cam shaft 60.

According to one embodiment of the present invention, the cross section of the protruding member 44 has a circular arc to be interacted with the cam tip 70 of the cam shaft 60. As such, the cam tip 70 can be located in a first position between the protruding member 44 and the first side wall 41, or in a second position between the protruding member and the second side wall 42. Because of the shape of the protruding member 44 and the urging force of the spring 90, the cam tip 70 cannot move freely between the first and second positions. Thus, each of the first and second positions is a mechanically stable position or a stable nose interface.

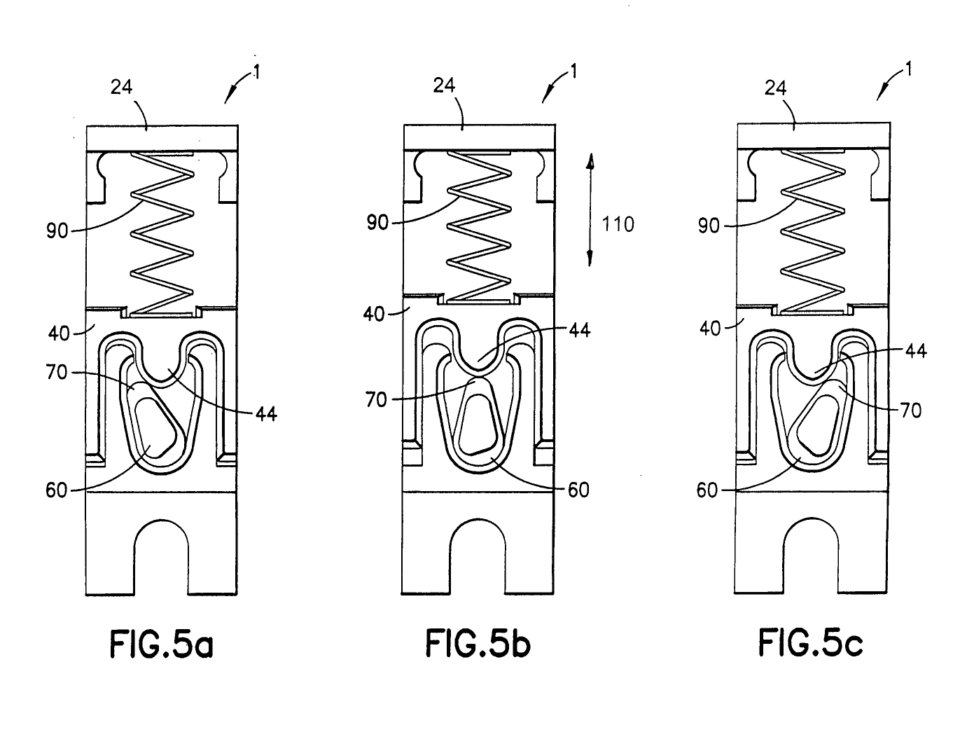

When the joint 62 is engaged with a lever, for example, the cam shaft can be moved from one stable nose interface to another against the urging force of the spring 90. As shown in FIG. 5a, the cam shaft is positioned in the first stable position between the protruding member and the first side wall. As shown in FIG. 5b, the cam shaft is in a transitional position, which is unstable. As shown in FIG. 5c, the cam shaft is positioned in the second stable position between the protruding member and the second side wall.

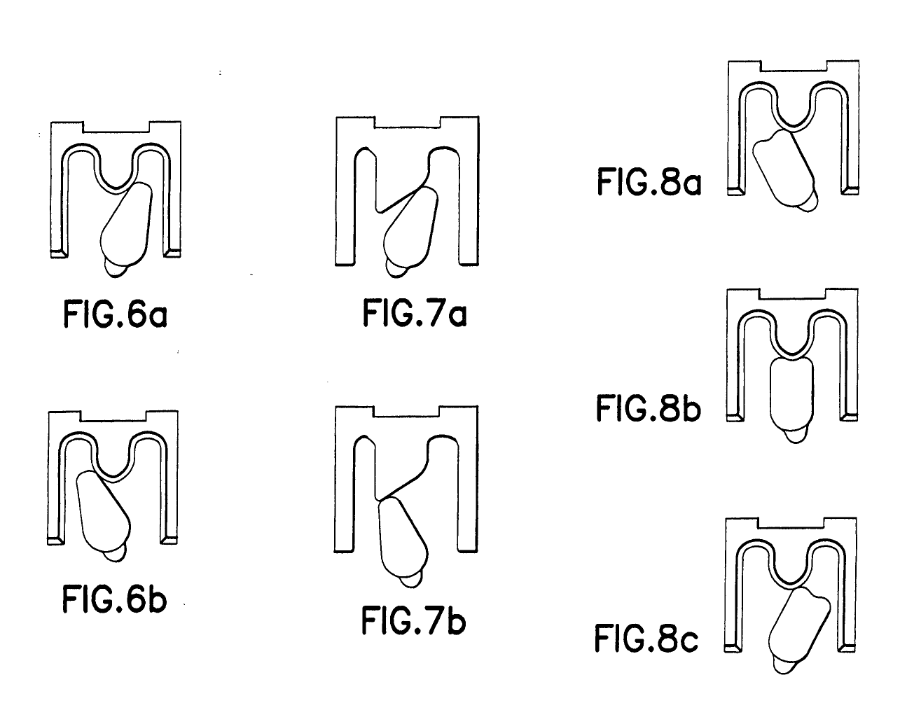

Depending on the shape of the protruding member of the slider and the shape of the cam tip of the cam shaft, the modular spring system can be bi-stable in that it has two stable nose-interface positions. FIGS. 6a and 6b show two such stable positions. The modular spring system can be mono-stable in that it has only one stable nose-interface position. FIG. 7a shows a stable position whereas FIG. 7b shows an unstable position. The modular spring system can have three or more stable positions. As shown in FIG. 8a, the cam tip and the protruding member forms a first stable nose interface. As shown in FIG. 8b, the cam tip and the protruding member forms a second stable nose interface. As shown in FIG. 8c, the cam tip and the protruding member forms a third stable nose interface.

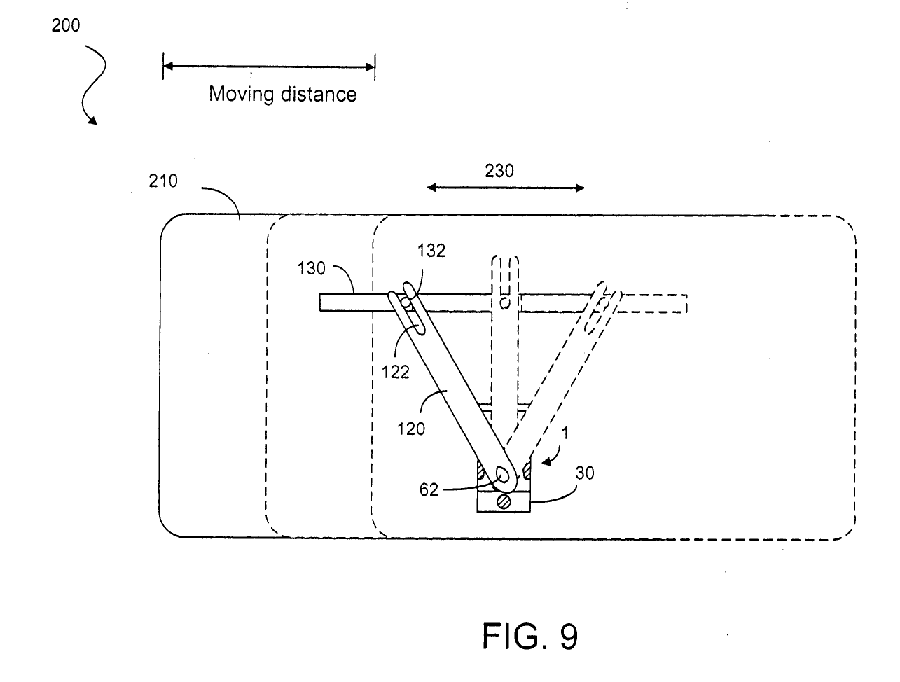

As shown in FIG. 9, a lever is mechanically coupled to the joint 62 (see FIG. 3) of the cam shaft 60 to change the nose interface positions while the modular spring system is fixedly mounted to a device base (not shown) of a device 200. As shown, the lever has a slot engaged with a pin on a slide bar. When the lever is caused to move the nose interface positions of the modular spring system, the slide bar can be shifted from one position to another in a linear movement along the moving direction 230. For example, if the slide bar is mounted on a different device part 210, this device part can be caused to slide against the device base.

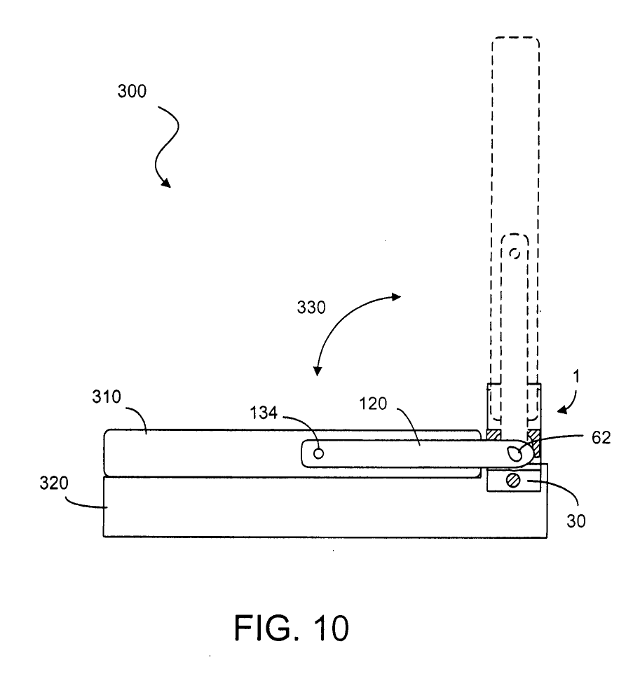

The modular spring system can also be used as a hinge in a foldable device 300. As shown in FIG. 10, the device 300 has a first device part 310 and a second device part 320. The modular spring system 1 is fixedly mounted on the second device part. A lever is mechanically coupled to the joint 62 of the cam shaft at one end of the lever. The other end of the lever is engaged with a pin on the first device part 310. As such, the modular spring system 1 can be used to provide two or more stable nose interface positions when the device is open or closed, allowing the first device part 310 to rotate relative to the second device part 320, as indicated by arrow 330.

In sum, the present invention provides a modular spring system which has a module body. The module body has a first end and an opposing second end defining a body axis. The modular spring system has means for mounting the module body to a device having a first device part and a second device part, the second device part movable relative to the first device part between a first device position and a second device position. The mounting means is depicted in FIG. 2 as the mounting bracket 30 and the mounting hole 26. The mounting bracket and mounting hole can be used to securely attach the module body to one of the device parts as shown in FIG. 10. The modular spring system has means for coupling the modular spring system to the another device part for maintaining at least one of the first and second device positions when the device is open or closed. The coupling means is depicted as a cam shaft 60 with a joint 62 in FIG. 3. The modular spring system has means, located on the first end of the module body; for holding the coupling means. The holding means is depicted as the cam shaft holder 12 in FIG. 2. The holding means having two arms defining a well for accommodating the cam shaft 62. The module spring system has means, located between the holding means and the second end, for retaining the cam shaft 60. The retaining means is depicted as the slider 40 in FIG. 4. The modular spring system also has means, located between the retaining means and a blocking means (end block 24) on the second end, for urging the protruding member of the retaining means to press against the coupling means. Th urging means is depicted as the spring 90 in FIG. 1.

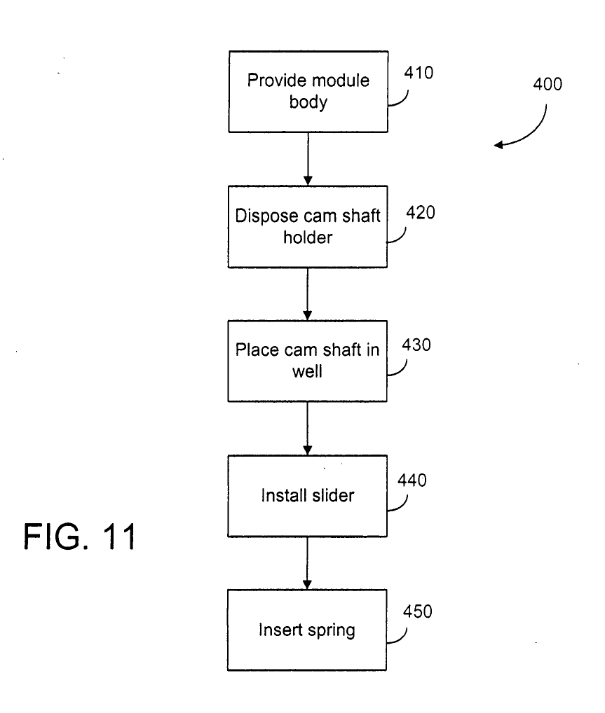

FIG. 11 is a flowchart illustrating the method of producing a modular spring system. As shown in the flowchart 400, a module body 10 is provided at step 410. The module body can be made of “silver steel” with an NC machine, for example. The disk-shape on the end block 24 can be the pin head of a pin. The pin has a stem (not shown) connected to the pin head. The stem can be forced into a hole (not shown) on the end block 24 for securely mounting the pin. The pin can also be made of “silver steel” with an NC machine, for example. At step 420, the cam shaft holder 12 is mounted on the module body. However, the cam shaft holder 12 can be an integral part of the module body 10 in manufacturing. At step 430, a cam shaft 60 is placed into the shaft well of the cam shaft holder 12. The cam shaft 60 can be made of “silver steel” with an NC machine, for example. It can also be mass produced by forging. At step 440, a slider 40 is moved into position using the slots 46 and alignment guides 18. Finally, a spring 90 is inserted between the slider 40 and the end block 24 at step 450. The spring 90 is depicted as a coil spring. However, other springs or urging mechanism can also be used for urging the slider to press against the cam tip.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A modular spring system comprising:
a cam shaft having a cam tip;
a module body having:
a first end and an opposing second end defining a body axis, the second end having an end block;
a cam shaft holder located on the first end, wherein the cam shaft holder has two arms defining a shaft well for placing the cam shaft therein, the shaft well having an open section facing the end block, and wherein the cam tip is positioned adjacent to the open section and the cam shaft is rotatable about a rotational axis substantially perpendicular to the body axis, allowing the cam tip to move between the two arms of the shaft well;
a retainer disposed between the cam shaft holder and the end block, the retainer having a protruding member facing the shaft well, wherein the retainer is slidable in a moving direction substantially parallel to the body axis; and
a spring located between the retainer and the end block for providing an urging force to urge the protruding member to the press against the cam tip through the open section of the shaft well while allowing the cam shaft to rotate about the rotational axis.

2. The modular spring system of claim 1, wherein the retainer has a first side wall and a second side wall located on opposite sides of the protruding member, and wherein the protruding member and the cam shaft are dimensioned to allow the cam tip to be positioned in a first position between the first side wall and the protruding member or in a second position between the second side wall and the protruding member.

3. The modular spring system of claim 2, wherein when the cam tip is moved between the first position and the second position, the retainer is caused to move in the moving direction toward the end block against the urging force.

4. The modular spring system of claim 2, wherein the cam tip has a recess portion, dimensioned to allow part of the protruding member to move into the recess portion in a third position between the first and second positions.

5. The modular spring system of claim 4, wherein when the cam tip is moved between the first position and the third position or between the second position and the third position, the retainer is caused to move in the moving direction toward the end block against the urging force.

6. The modular spring system of claim 1, wherein the retainer has a first side, an opposing second side and at least a side wall on the first side, and wherein the protruding member and the cam shaft are dimensioned to allow the cam tip to be positioned in a first position between the side wall and the protruding member.

7. The modular spring system of claim 6, wherein the cam shaft can be caused to rotate such that the cam tip is moved toward the second side to a second position between the side wall and the protruding member while the retainer is caused to move in the moving direction toward the end block against the urging force.

8. The modular spring system of claim 7, wherein when the cam tip is moved from the second position to the first position, the retainer is caused by the urging force to move toward the cam shaft holder.

9. The modular spring system of claim 2, wherein the retainer has a slot on the first side wall and another slot of the second side wall, and the module body has two guiding members located on opposing sides of the cam shaft holder, wherein each of the guiding members lies in an axis substantially parallel to the body axis, and wherein the slots are dimensioned to allow the guiding members to move into the slot and to restrict movement of the retainer to the moving direction substantially parallel to the body axis.

10. The modular spring system of claim 1, wherein the cam shaft has a joint dimensioned to engage with a coupling tool for rotating the cam shaft about the rotational axis.

11. The modular spring system of claim 2, wherein the shaft well has a recess portion and the cam shaft has a protruding section for engaging with the recess portion, so as to keep the cam shaft in the shaft well while allowing the cam shaft to rotate about the rotational axis when the cam tip is moved between the first and second positions.

12. A device comprising:
a first device part;
a second device part movable relative to the first device part between a first device position and a second device position;
a modular spring system mounted on the first device part, the modular spring system comprising:
a cam shaft having a cam tip;
a module body having:
a first end and an opposing second end defining a body axis, the second end having an end block;
a cam shaft holder located on the first end, wherein the cam shaft holder has two arms defining a shaft well for placing the cam shaft therein, the shaft well having an open section facing the end block, and wherein the cam tip is positioned adjacent to the open section and the cam shaft is rotatable about a rotational axis substantially perpendicular to the body axis, allowing the cam tip to move between the two arms of the shaft well;
a retainer disposed between the cam shaft holder and the end block, the retainer having a protruding member facing the shaft well, wherein the retainer is slidable in a moving direction substantially parallel to the body axis; and
a spring located between the retainer and the end block for providing an urging force to urge the protruding member to the press against the cam tip through the open section of the shaft well while allowing the cam shaft to rotate about the rotational axis; and
a coupler having a first coupling end mechanically coupled to the second device part, and a second coupling end coupled to the modular spring system for rotating the cam shaft so as to cause the second device part to move between the first and second device positions.

13. The device of claim 12, wherein the retainer has a first side wall and a second side wall located on opposite sides of the protruding member, and wherein the protruding member and the cam shaft are dimensioned to allow the cam tip to be positioned
between the first side wall and the protruding member when the second device part is in the first device position, and
between the second side wall and the protruding member when the second device part is in the second device position.

14. The device of claim 12, wherein the first device part is mechanically coupled to the second device part through a hinge to allow the second device part to rotate relative to the first device part for closing and opening the device, and wherein the second device part is in the first device position when the device is closed and the second device part is in the second device position when the device is open.

15. The device of claim 12, wherein the first device part is mechanically coupled to the second device part through a sliding mechanism to allow the second device part to slide against the first device part for closing and opening the device, and wherein the second device part is in the first device position when the device is closed and the second device part is in the second device position when the device is open.

16. A method comprising:
providing in a modular spring module a module body having first end and an opposing second end defining a body axis;
disposing a cam shaft holder on the first end and an end block on the second end, the cam shaft holder having two arms defining a shaft well with an open section facing the end block;
disposing a cam shaft in the shaft well, the cam shaft having a cam tip located adjacent to the open section, wherein the cam shaft is rotatable about a rotational axis substantially perpendicular to the body axis, allowing the cam tip to move between the two arms of the shaft well;
disposing a retainer between the cam shaft holder and the end block, the retainer having a protruding member facing the shaft well, wherein the retainer is slidable in a direction substantially parallel to the body axis; and
disposing a spring between the retainer and the end surface for urging the protruding member to press against the cam tip while allowing the cam shaft to rotate about the rotational axis.

17. The method of claim 16, further comprising:
providing a mounting member on the module body so as to allow the modular spring module to be mounted on a device having a first device part and a second device part movable relative to the first device part between a first device position and a second device position; and
disposing a coupling member on the cam shaft for engaging with a coupling tool so as to rotate the cam shaft about the rotational axis between a first shaft position and a second shaft position when the second device part is moved between the first device position and the second device position.

18. A modular spring system comprising:
a module body having a first end and an opposing second end defining a body axis;
means configured for mounting the module body to a device having a first device part and a second device part, the second device part movable relative to the first device part between a first device position and a second device position;
means configured for coupling the modular spring system to the second device part for maintaining at least one of the first and second device positions when the second device part is positioned in one of the first and second device positions, the coupling means having a coupler body with a protruding section;
means, located on the first end of the module body; for holding the coupling means, wherein the holding means having two arms defining a well for accommodating the coupler body therein, the well having an open section facing the second end, allowing the coupler body to rotate about a rotational axis with the protruding section located between the two arms adjacent to the open section, the rotational axis substantially perpendicular to the body axis;
means, located between the holding means and the second end, for retaining the coupler body of the coupling means in the well, the retaining means having a protruding member facing the open section of the well, wherein the retaining means is slidable in a direction substantially parallel to the body axis; and
means, located between the retaining means and a blocking means on the second end, for urging the protruding member of the retaining means to press against the protruding section of the coupling means while allowing the coupler body to rotate about the rotational axis.

19. The modular spring system of claim 18, wherein the retaining means has a first side wall and a second side wall located on opposite sides of the protruding member, and wherein the protruding member and the coupling means are dimensioned to allow the protruding section to be positioned in a first position between the first side wall and the protruding member or in a second position between the second side wall and the protruding member.
